(19) United States
(12) Patent Application Publication
(10) Pub. No.: US 2017/0341763 A1
(43) Pub. Date: Nov. 30, 2017

(54) NONE

(71) Applicant: LIEBHERR-AEROSPACE TOULOUSE SAS, Toulouse (FR)

(72) Inventors: Jean-Yves BIDAULT, TOULOUSE (FR); Brice TEULIE, FRONTON (FR)

(21) Appl. No.: 15/602,727

(22) Filed: May 23, 2017

(30) Foreign Application Priority Data
May 26, 2016 (FR) 16.54745

(51) Int. Cl. B64D 13/06; G05D 7/01; F16K 15/03; B60H 1/00

(52) U.S. Cl. CPC B64D 13/06; F16K 15/035; G05D 7/0173; B64D 2013/0603; B60H 1/00678; B64D 2013/0688

(57) ABSTRACT

Disclosed is an air mix valve including: a wall having at least three openings; and at least one airflow-regulating device. The airflow-regulating device includes: at least two shutters placed in the internal volume of the valve, at least one aerodynamic shutter of which is arranged with respect to one of the openings so as to be able to receive an airflow passing through this opening, and a linking mechanism between at least two shutters. Each of the shutters is arranged and guided so as to be able to be caused to move with respect to the wall. At least one airflow-regulating device, named aero-controlled regulation device, is mounted to be freely movable under the effect of aerodynamic energy from airflows passing through the openings.

The invention relates to an air mix valve comprising at least one airflow-regulating device.

Air-conditioning systems allowing an airflow to be injected into an enclosed space so as to regulate climatic conditions of this enclosed space generally comprise air mix valves allowing several airflows to be mixed so as to regulate the airflow injected into the enclosed space whilst allowing recirculation of the air and the mixing of the air from the enclosed space with the air from outside of the enclosed space to be air-conditioned and/or heated air from the enclosed space to be air-conditioned and/or cooled air also from the enclosed space to be air-conditioned. For example, some air-conditioning systems, such as ECS (Environmental Control Systems) allow conditioned air to be provided to the cockpit and to passengers of an aircraft.

The mix valves allow an airflow to be sent towards at least one outlet of the valve, the sent airflow being able to be a mix of an airflow from an inlet or several inlets of the mix valve selectively. In order to guide and regulate the different airflows from different inlets of the mix valve, the mix valves generally comprise shutters allowing the airflows to be regulated. These shutters are generally positioned at the inlets and outlets of the mix valves. Thus, these shutters allow the passage of the airflow when they are in the open position and prevent the passage of the airflow when they are in the closed position. There are known, in particular, shutters able to prevent the retrograde passage of an airflow through an inlet of the valve towards the outside of the mix valve. These shutters are named non-return shutters. Known non-return shutters are generally biased into the closed position for example by a mechanism having a spring. However, this type of mechanism generates significant load losses which are detrimental to numerous applications, in particular on-board vehicles, more particularly in air-conditioning systems in aircrafts in which the recirculated air is at low pressure.

There are also known valves comprising at least two shutters connected by a connecting rod allowing the shutters to be moved oppositely to each other such that when one shutter is open, the other shutter is closed. For example, FR 2757594 describes an air inlet shutter control device, in particular for an air-conditioning system. The control device comprises two rotatably mounted levers with two shutters. The control device likewise comprises a connecting rod having ends connected to the levers by joints with parallel axes able to jointly drive the two levers such that they move oppositely to each other (when one of the two shutters is open, the second is closed). In order to modify the position of the shutters, the connecting rod is moved by a control member such as a cable. Such a device is relatively complex, has numerous parts, is heavy and is likely to malfunction, which is particularly detrimental to a system on-board a vehicle and in particular on-board an aircraft or a spaceship.

There are also known devices in which pneumatic regulation is ensured via high-pressure air jets acting on different shutters selectively. These devices are also relatively complex, difficult to perfect and are not well suited to being integrated in low-pressure air-conditioning systems. Furthermore, pneumatic regulation generates a permanent loss of aerodynamic energy which is to be avoided in low-pressure air-conditioning systems of vehicles, in particular aircraft.

The invention thus aims to overcome these disadvantages.

The invention thus relates to a mix valve in which the movement of the shutters is not effected using mechanical control members.

The invention also aims to reduce the number of mechanical elements allowing the operation of a mix valve so as to limit the overall dimensions and the weight of the elements needed to operate the valve.

The invention also aims to propose such a mix valve which is less expensive.

The invention thus aims to propose a valve which is autonomous in terms of energy and operation, and has a low energy consumption.

The invention also aims to propose such a valve minimising the load losses and able to operate with at least two low-pressure airflows.

The invention also aims to propose such a valve which can be controlled in a simple manner, with a low amount of energy needed to effect this control.

The invention also aims to propose such a valve which has a very long service life, a very high degree of reliability, is not prone to malfunction and can be maintained in a simple and inexpensive manner.

The invention aims in particular to propose such a valve which is able to be integrated on-board a vehicle, in particular on-board an aircraft or a spaceship, more particularly in an air-circulating circuit of a low-pressure air-conditioning system.

To this end, the invention relates to an air mix valve comprising:

a wall delimiting an internal volume of the valve and having at least three openings,

at least one airflow-regulating device comprising:
at least two shutters placed in the internal volume of the valve, at least one of which, named aerodynamic shutter, is arranged with respect to one of the openings so as to be able to receive an airflow passing through this opening,
a linking mechanism between at least two shutters,

at least one of the shutters being guided with respect to the wall, each of the shutters being arranged and guided so as to be able to be caused to move with respect to the wall, characterised in that:

at least one airflow-regulating device, named aero-controlled regulation device, is mounted to be freely movable with respect to the wall, so as to be able to be displaced exclusively under the effect of variations in at least part of the airflow passing through at least some of the openings,

at least one aerodynamic shutter of at least one aero-controlled regulation device, named profiled shutter, has the shape of a blade profile comprising a leading edge and a trailing edge and having a non-constant thickness between its leading edge and its trailing edge, so as to be able to be caused to move by the aerodynamic energy of at least one airflow which is incident on this profiled shutter,

at least one shutter, named linked shutter, of the aero-controlled regulation device, is connected to at least one profiled shutter of this aero-controlled regulation device by a linking mechanism arranged such that such a linked shutter is caused to move by a movement of at least one profiled shutter to which it is connected by the linking mechanism.

In a blade profile, the leading edge is an end portion of the profile which has a maximum curvature and which is located furthest upstream of the incident airflow. The trailing edge is an end of the profile which has a minimum radius of curvature and which is located furthest downstream of the incident air flow. The leading edge is an end of the profile having a local minimum radius of curvature and is in general closer than the trailing edge to a portion of the profile having the greatest thickness.

A mix valve in accordance with the invention allows the airflows to be used to control at least some—in particular all—of the shutters of the mix valve. In fact, the airflows acting on the shutters are generally considered to be detrimental in terms of controlling the shutters because the pressures exerted thereby on these shutters may crack them open, an undesired airflow thus being able to be introduced into the mix valve. However, in an unexpected manner, the inventors have in contrast determined that in reality it is possible to use and exploit the pressures and the aerodynamic energy, even when of low magnitude, exerted on the shutters by the airflows in order to open and close the shutters in a controlled manner.

Thus, the invention enables, for the first time, a mix valve to be obtained which comprises an aero-controlled regulation device operating at least in part—in particular completely—due to at least some of the airflows incident on the shutters thereof. A valve in accordance with the invention thus enables the use of one or more members for controlling the movement of the shutters to be omitted whilst retaining the same level of functionality. The aero-controlled regulation device is thus mounted on the wall and is guided exclusively with respect to the wall. The absence of mechanical control members enables in particular the mix valve to be reduced in weight and to be simplified considerably so as to improve its longevity, reliability and service life.

More particularly, the openings of an air mix valve in accordance with the invention define:

at least one air inlet, each air inlet being adapted to send an incoming airflow into a mix chamber of the valve delimited by the wall of the mix valve, the mix chamber being adapted to form at least one outgoing airflow from each incoming airflow,

at least one air outlet, each air outlet being adapted to extract an outgoing airflow from the valve.

However, it should be noted that in some embodiments of the invention, a single opening of the valve, named air inlet/outlet opening, can be used sometimes as an air inlet, sometimes as an air outlet of the valve. In particular, an air inlet/outlet opening is either an air inlet or an air outlet depending upon the position taken by at least one regulation device of the valve.

Thus, a valve comprises either at least two air inlet openings and at least one air outlet opening, or at least one air inlet opening and at least two air outlet openings, or at least one air inlet opening, at least one air inlet/outlet opening and at least one air outlet opening. Furthermore, a profiled shutter of a valve in accordance with the invention is adapted such that the aerodynamic energy of an airflow incident on this profiled shutter exerts an aerodynamic force on this profiled shutter able to cause the movement of, on the one hand, this profiled shutter itself and, on the other hand, each linked shutter connected to the profiled shutter by a linking mechanism.

This aerodynamic force can be a lift force resulting from the flow of the airflow around the profiled shutter having a periphery defining a closed curve.

In particular, at least one profiled shutter can be caused to move by aerodynamic energy of an airflow, named low-pressure airflow, under relative static pressure greater than or equal to 2 hPa, incident on this profiled shutter.

In certain advantageous embodiments, at least one profiled shutter has a cambered blade profile. The profile of this profiled shutter is thus non-symmetrical and has, owing to this camber, a face which is more concave, named intrados, than its other face which is more convex, named extrados.

Furthermore, in certain advantageous embodiments in accordance with the invention, at least one profiled shutter is cambered so as to be able to form, in at least one position of aerodynamic balance of this shutter with respect to the wall of the valve, a converging/diverging passage of airflow between this shutter and the wall of the valve, i.e. a passage having a portion having a cross-section decreasing over its length and extended by a portion having a cross-section increasing over its length. More particularly, said converging/diverging passage is formed between the concave intrados of the profiled shutter and the wall of the valve in said position of aerodynamic balance of the profiled shutter. The airflow accelerates, under the Venturi effect, in the portion having a section decreasing over its length such that the airflow incident on the profiled shutter is faster on the intrados than on the extrados. Therefore, the Venturi effect allows an aerodynamic force on the shutter to be directed from the extrados towards the intrados of the profiled shutter.

In certain advantageous embodiments of a valve in accordance with the invention, each shutter of a regulation device—in particular each shutter of an aero-controlled regulation device—is articulated with respect to the wall by a pivot link so as to be able to pivot between two end positions.

More particularly, each profiled shutter of an aero-controlled regulation device is articulated to the wall by a pivot link along a pivot axis passing at least substantially through an aerodynamic centre of this profiled shutter. The aerodynamic centre of a profiled shutter is defined by the fixed point with respect to which the moment of the aerodynamic force is constant and non-zero regardless of the incidence of the incident airflow. Such an arrangement of the pivot axis allows the rotation of the profiled shutter about the pivot axis to be optimised. Furthermore, the pivot axis of a profiled shutter is offset with respect to a point of application, named centre of pressure, of the resultant of the aerodynamic forces generated on this profiled shutter. Thus, an aerodynamic flow is able to cause the rotational movement of this profiled shutter towards an opening end position.

Furthermore, at least one shutter—in particular each shutter—of at least one aero-controlled regulation device is associated with an opening, named associated opening, having a passage cross-section, the surface area of which depends upon the position of said shutter.

Each shutter of a regulation device of a valve in accordance with the invention is guided with respect to the wall and/or with respect to at least one other shutter of the regulation device.

Advantageously and in accordance with the invention, at least one shutter—in particular at least one shutter of an aero-controlled regulation device—is associated with an opening defining an air inlet or an air outlet or even with an air inlet/outlet of the mix valve. A valve in accordance with the invention can thus comprise at least one shutter which is not associated with an opening, for example a shutter—in particular a profiled shutter—interposed within the valve.

Furthermore, in certain embodiments of the invention, each shutter associated with an opening of an aero-controlled regulation device is adapted to be able to pivot between an opening end position, allowing an airflow to pass through the associated opening, and a closing end position, preventing at least in part an airflow from passing through the associated opening.

In particular, at least one profiled shutter and at least one linked shutter of an aero-controlled regulation device are adapted to be able to be held in a position exclusively under the effect of at least part of an airflow passing through at least some of the openings. Thus, a linked shutter and a profiled shutter of an aero-controlled regulation device can be held in its opening end position or in its closing end position or even in any intermediate position between its opening end position and its closing end position.

More particularly, a valve in accordance with the invention advantageously has shutters having dimensions similar to those of the openings of the valve. Such shutters are thus able to allow or prevent the passage of an airflow through the openings with which they are associated. An aero-controlled regulation device in accordance with the invention thus allows the different airflows to be regulated. However, there is nothing to prevent provision being made that the valve comprises shutters with dimensions less than those of the openings of the valve and only allowing the airflow to be guided.

The shutters of a single regulation device of a valve in accordance with the invention can be arranged so as to be caused to move all in the same direction (opening direction or closing direction) between their opening end position and closing end position, or in contrast in opposite directions to each other in pairs, or in any other kinematic relationship. More particularly, in some embodiments of the invention, at least one shutter associated with an opening of an aero-controlled regulation device is arranged to be able to be caused to pivot towards a closing end position when at least one other shutter of the same aero-controlled regulation device pivots towards an opening end position. Thus, in certain embodiments of the invention, when at least a first shutter of the aero-controlled device is in the opening end position, at least a second shutter of the device is in the closing end position, and vice-versa.

Furthermore, the shutters of a single regulation device of a valve in accordance with the invention can be arranged so as to pivot all in the same rotational direction, or in contrast in opposite rotational directions to each other in pairs, or in any other kinematic relationship. More particularly, in certain embodiments of the invention, at least one shutter of an aero-controlled regulation device is arranged to pivot in the same rotational direction as at least one other shutter of the same aero-controlled regulation device.

An aero-controlled regulation device in accordance with the invention may thus be able to prevent an airflow, from the opening with which a first open shutter of the aero-controlled regulation device is associated, from passing through the opening with which a second closed shutter of the aero-controlled regulation device is associated.

In certain embodiments in accordance with the invention, the linking mechanism between the shutters of an aero-controlled regulation device comprises at least one connecting rod connecting two shutters of this aero-controlled regulation device.

A linking mechanism with connecting rod(s) has a simple structure and has small overall dimensions. In certain advantageous embodiments, a connecting rod has a first end mounted—in particular articulated—on a shutter of the aero-controlled regulation device and a second end mounted—in particular articulated—on another shutter of this same aero-controlled regulation device.

In certain other embodiments, the linking mechanism comprises a main connecting rod and two secondary connecting rods, named small connecting rods, with dimensions smaller than those of the main connecting rod. In particular, a first end of each small connecting rod is mounted on a shutter of the regulation device. Furthermore, each end of the main connecting rod is mounted—in particular articulated—on a second end of a small connecting rod.

More particularly, in certain embodiments of the invention, the pivot link articulating each shutter to the wall, and a link articulating each shutter to the linking mechanism, are pivot links along axes which are in parallel with each other and offset with respect to each other.

In certain embodiments, the distance between the axis of the pivot link articulating a first shutter to the wall and the axis of the link articulating this first shutter to the linking mechanism is different from the distance between the axis of the pivot link articulating a second shutter, of the same aero-controlled regulation device, to the wall and the axis of the link articulating this second shutter to the linking mechanism. Thus, the first shutter and the second shutter are caused to move at different angles with respect to their opening and closing end positions. However, there is nothing to prevent provision being made, as an alternative, that the distance between the axis of the pivot link articulating a first shutter to the wall and the axis of the link articulating this first shutter to the linking mechanism is equal to the distance between the axis of the pivot link articulating a second shutter (of the same aero-controlled regulation device) to the wall and the axis of the link articulating this second shutter to the linking mechanism.

Furthermore, the invention can be applied to any possible respective arrangements of the shutters with respect to each other and with respect to the different openings of the valve.

In certain embodiments, a valve in accordance with the invention comprises a single aero-controlled regulation device which can be the only regulation device of the valve. Furthermore, as an alternative or in combination, a valve in accordance with certain embodiments of the invention comprises a single profiled shutter associated with an opening—i.e. arranged to be able to receive an incoming or outgoing airflow passing through this opening—intended to receive an incoming low-pressure airflow.

Furthermore, in certain embodiments in accordance with the invention, each shutter linked with a profiled shutter is associated with an opening which is different from an opening with which the profiled shutter is associated.

In certain embodiments, a valve in accordance with the invention comprises an aero-controlled regulation device selected from the group comprising:
an aero-controlled regulation device comprising a profiled shutter and a linked shutter, these two shutters being connected by a mechanism to at least one—in particular a single—connecting rod articulated on the shutters,
an aero-controlled regulation device comprising a profiled shutter and two linked shutters, these shutters being connected by a mechanism with connecting rods articulated on the shutters,
an aero-controlled regulation device comprising two profiled shutters and a linked shutter, these shutters being connected by a mechanism with connecting rods articulated on the shutters,
an aero-controlled regulation device comprising two profiled shutters and two linked shutters, these shutters being connected by a mechanism with connecting rods articulated on the shutters.

In certain embodiments, a valve in accordance with the invention comprises an aero-controlled regulation device comprising a profiled shutter and a linked shutter, these two shutters being associated with two different openings—in particular two openings intended to receive incoming airflows—of the valve.

That being said, there is nothing to prevent the provision of several shutters—profiled or not—associated with a single opening of the valve, and/or a single shutter—profiled or not—associated with several openings of the valve, for example articulated to the wall between two openings for, in one position, closing a first opening and leaving a second opening open, and, in another position, opening the first opening and closing the second opening.

Other variations and combinations of arrangements are possible.

More particularly, in one advantageous embodiment, the mix valve comprises at least one stop able to limit the rotation of at least one shutter of a regulation device in one direction about the axis of the pivot link articulating the shutter to the wall.

Such stops can allow the end positions of the shutters to be defined. Thus, a stop defining a closing end position of a shutter will be placed on the wall in the vicinity of the opening associated with the shutter. More particularly, in certain advantageous embodiments, the stop is arranged to receive and block the end of a shutter furthest away from the pivot when the shutter is in the closing end position.

The invention also relates to an air-conditioning system comprising at least one air mix valve in accordance with the invention.

More particularly, an air-conditioning system in accordance with the invention comprises at least one airflow generating device able to be controlled between at least two different states in which it generates airflows with different characteristics, including at least one state in which it generates an airflow with a non-zero flow rate. Such an airflow generating device able to be controlled can be a fan or any other air flow rate source able to be controlled between at least two different states. Such an airflow generating device able to be controlled can be controlled from an e.g. electronic or computer-based automatic control arrangement. Such an automatic control arrangement can have, for example, a temperature-regulating device incorporated therein.

In certain advantageous embodiments, an air-conditioning system in accordance with the invention comprises at least one airflow generating device—able to be controlled or not—able to generate a low-pressure airflow which can exert an aerodynamic force on at least one profiled shutter of an aero-controlled regulation device of an air mix valve.

In particular, an air-conditioning system in accordance with the invention comprises an airflow generating device adapted to generate a low-pressure airflow being introduced into the mix valve through at least one opening associated with a profiled shutter of an aero-controlled regulation device in accordance with the invention so as to control the opening and closing of this profiled shutter on which aerodynamic forces of the airflow produced by the airflow generating device are exerted Furthermore, preferably, the flow rate of the low-pressure airflow generated by the airflow generating device is greater than the flow rate of the airflows from other air inlet openings of the valve.

The invention also relates to a vehicle comprising an air-conditioning system in accordance with the invention.

The invention also relates to an air mix valve, an air-conditioning system and a vehicle which are characterised in combination by all or some of the features mentioned above or below.

Other aims, features and advantages of the invention will become apparent upon reading the following description given by way of non-limiting example and which makes reference to the attached figures in which:

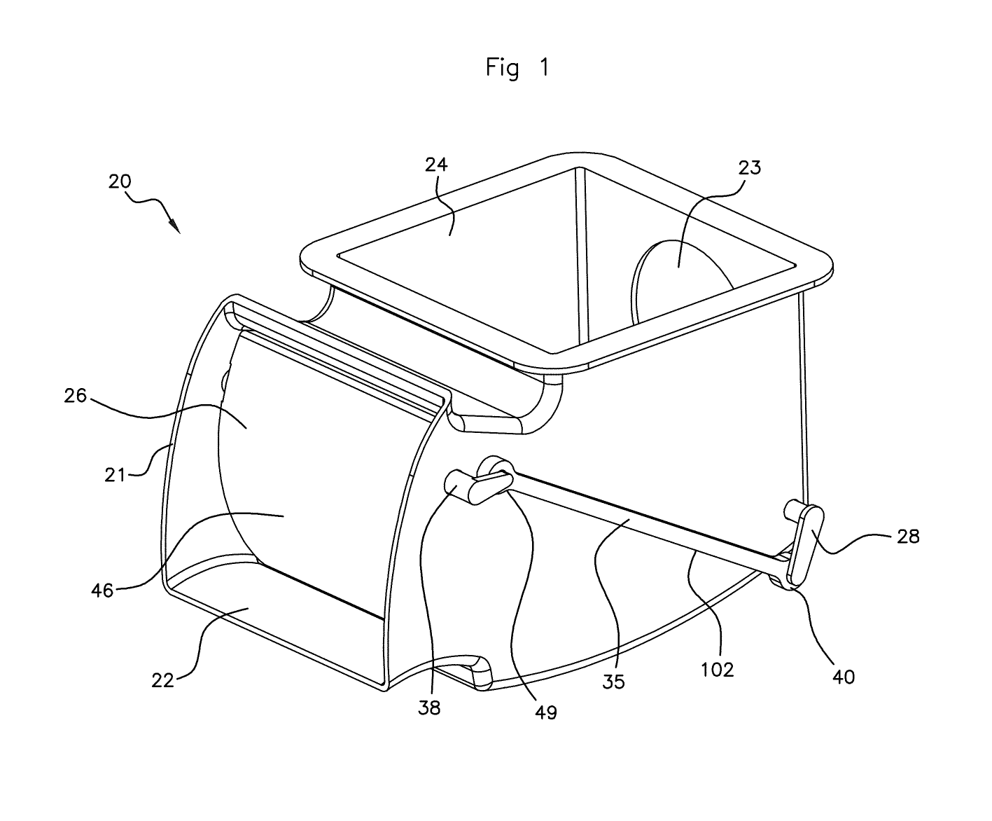

FIG. 1 is a schematic perspective view of a mix valve in accordance with a first embodiment of the invention,

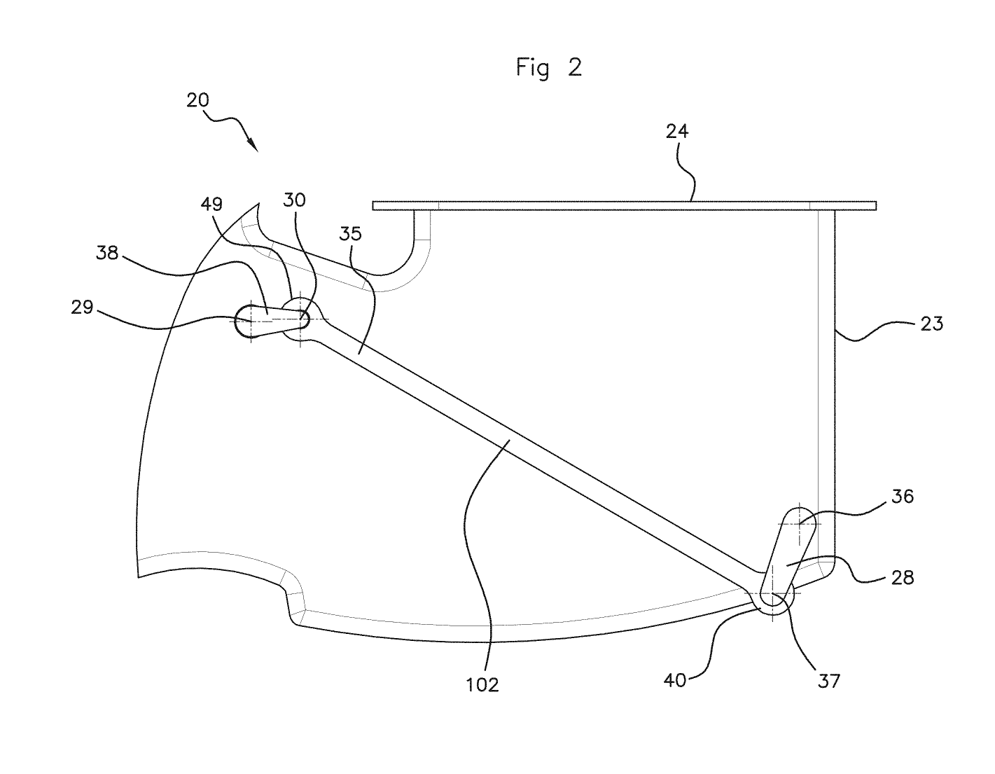

FIG. 2 is a schematic side view of the mix valve of FIG. 1,

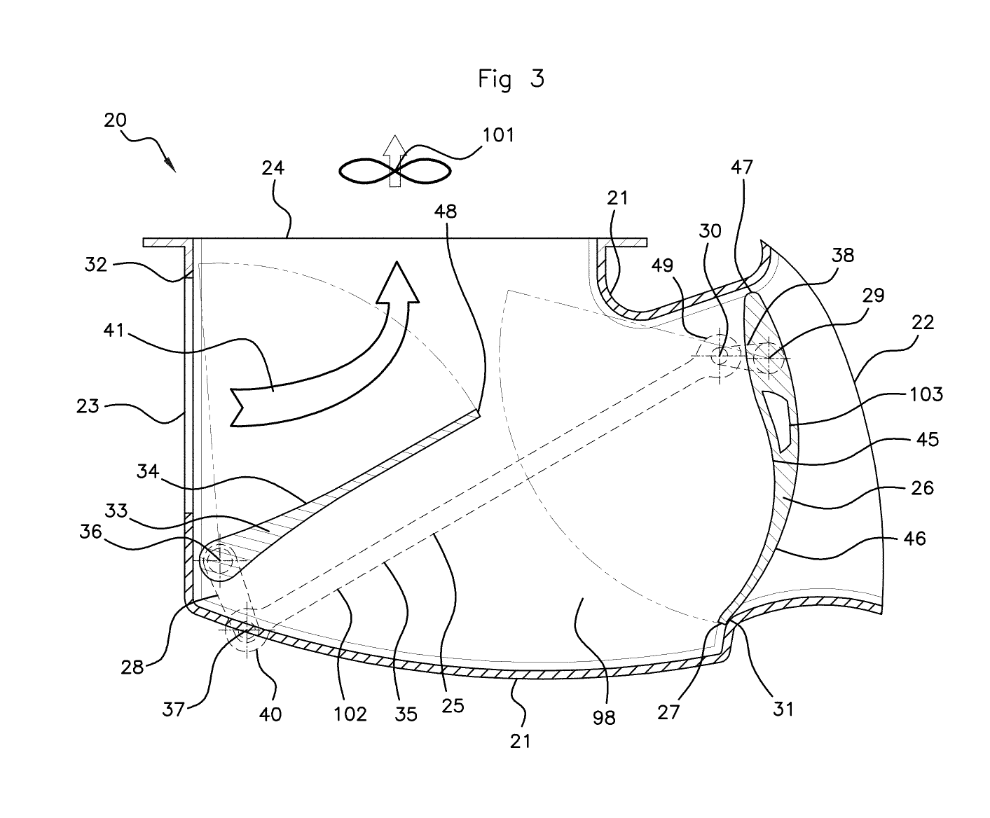

FIG. 3 is a schematic, axial cross-sectional view of the mix valve of FIG. 1, a profiled shutter of a regulation device being in the closing end position and a linked shutter of the same regulation device being in the opening end position,

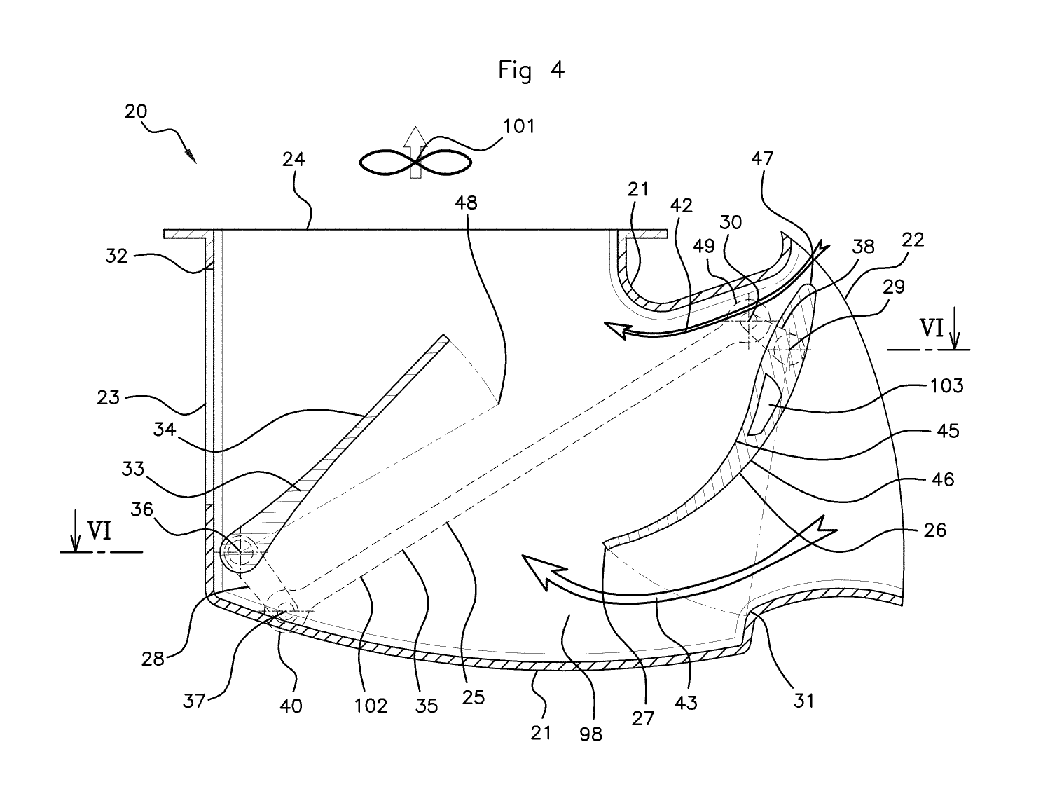

FIG. 4 is a schematic, axial cross-sectional view of the valve of FIG. 1, the two shutters of the regulation device being in an intermediate rotational position,

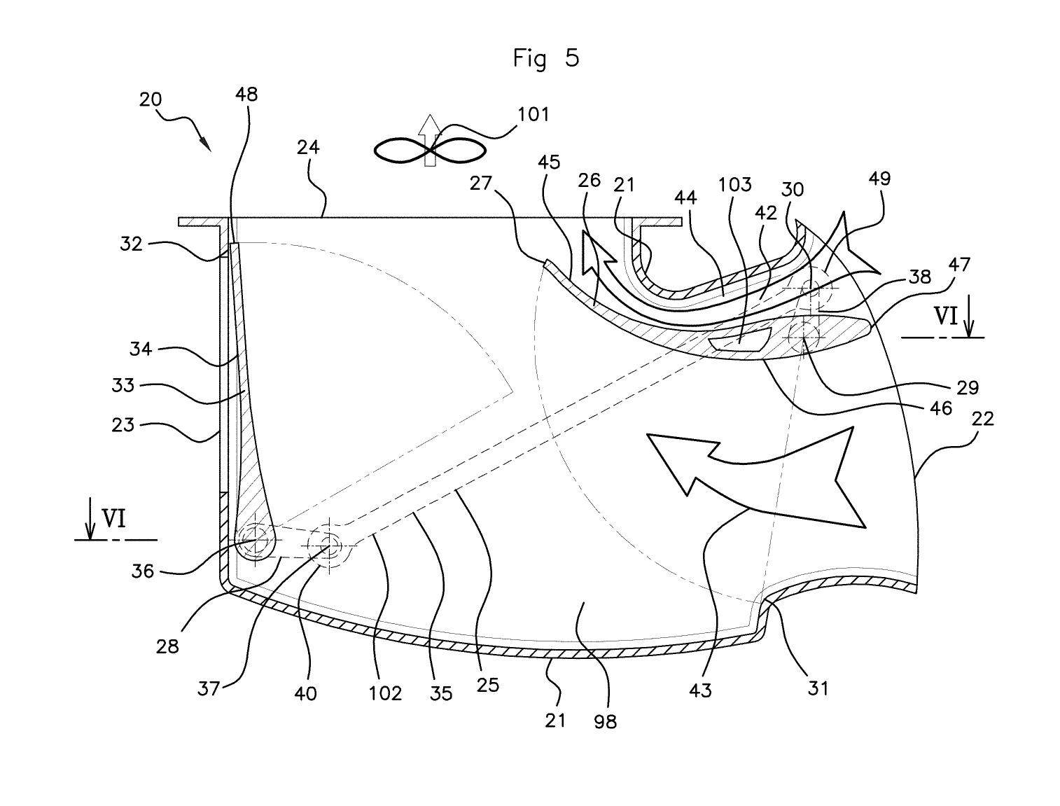

FIG. 5 is a schematic, axial cross-sectional view of the valve of FIG. 1, the profiled shutter of the regulation device being in the opening end position and the linked shutter of the same regulation device being in the closing end position,

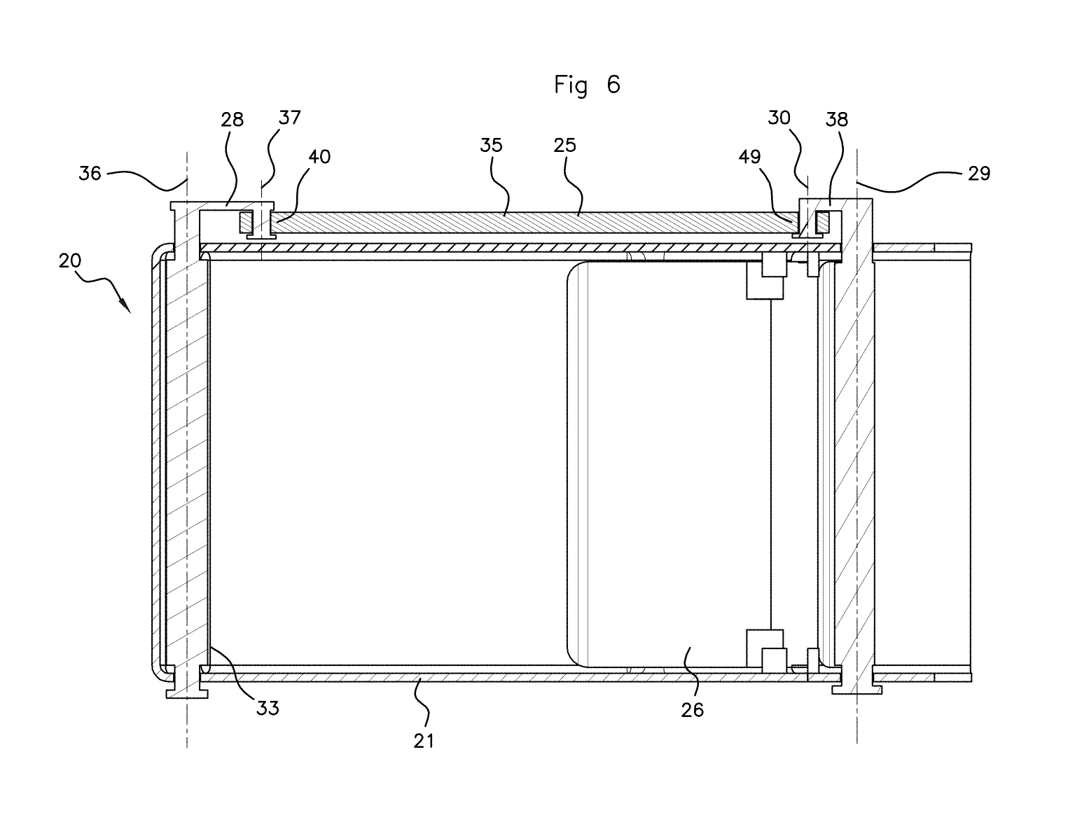

FIG. 6 is a schematic, transverse cross-sectional view along line VI-VI in FIG. 4,

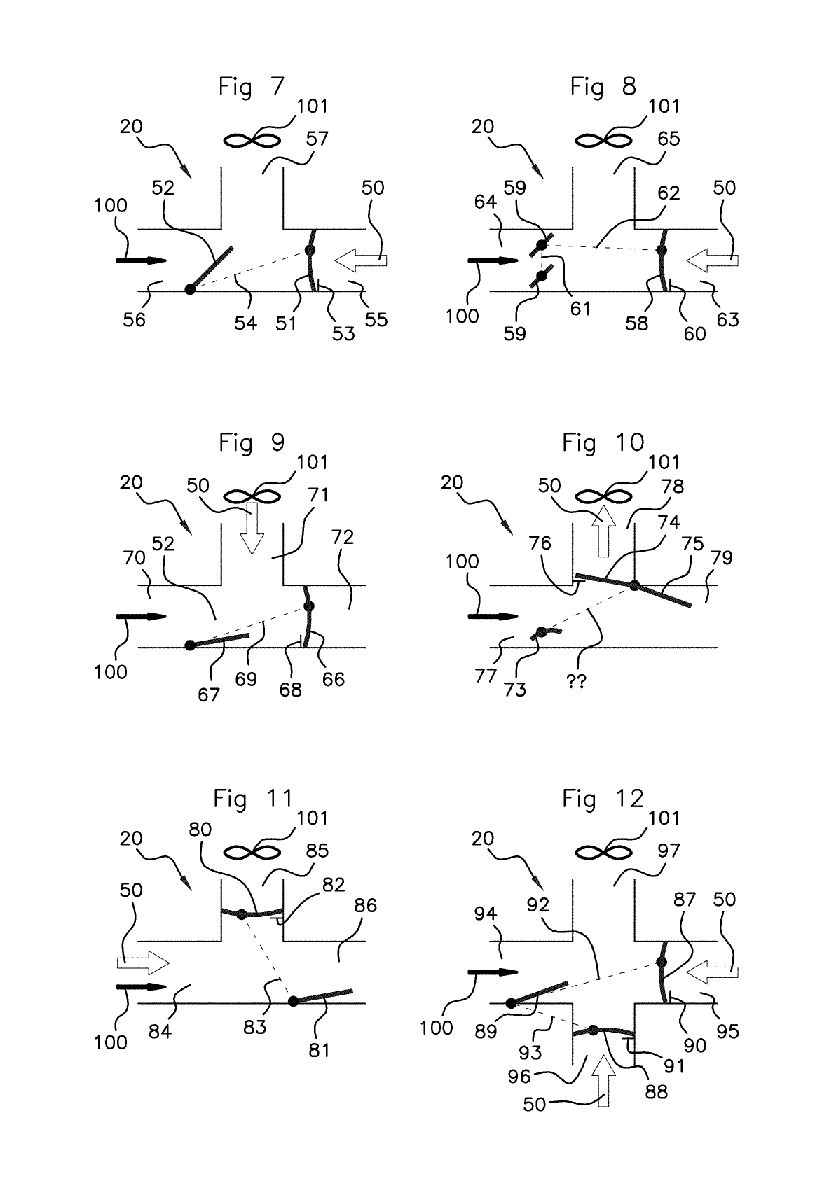

FIGS. 7 to 12 are diagrams of other embodiments of a valve in accordance with the invention.

An air mix valve 20 in accordance with the invention, shown in a first embodiment in FIGS. 1 to 6, comprises a wall 21 delimiting a mix chamber 98 and having three openings 22, 23, 24. The mix chamber 98 is formed within the mix valve 20 between the openings 22, 23, 24 of the valve 20.

For example, each opening 22, 23, 24 can be connected to a ventilation line of an air-conditioning system or can issue directly onto an enclosed space to be air-conditioned. More particularly, the air-conditioning system can comprise different members (such as a heat exchanger, pressurisation device, oxygen tank, . . . ) allowing at least one airflow to be guided and regulated to one or more outlets issuing onto an enclosed space to be air-conditioned such as a cab/cabin of a vehicle, an enclosed room or the like.

An airflow can thus pass through each opening 22, 23, 24 of the valve 20. A mix valve 20 is thus able to mix and/or guide one or more airflows, named incoming airflows, from one or more openings used as airflow inlets and to extract, through one or more openings used as air outlets, the mix airflow formed in a mix chamber 98 of the mix valve 20, named outgoing airflow. However, there is nothing to prevent a single opening from being used as the air inlet and outlet.

For example, in the embodiment shown in FIGS. 1 to 6, the openings 22 and 23 of the mix valve 20 are air inlets and the opening 24 of the mix valve 20 is an air outlet. The outgoing airflow can thus come from a single incoming airflow or even be formed from a mixture of several incoming airflows entering the mix chamber 98 through the openings 22 and 23.

More particularly, an airflow 41 flowing towards the mix chamber 98 can pass through the opening 23. Furthermore, an incoming airflow 42, 43 flowing towards the mix chamber 98 can pass through the opening 22. Furthermore, other incoming airflows can be sent to the mix valve 20 through the other air inlet openings of the mix valve 20, such as the opening 23. Each incoming air flow can, for example, be a cold airflow, a hot airflow, these flows being able to be recirculation airflows from the enclosed space to be air-conditioned such as an aeroplane cabin or even from the outside of this enclosed space. Thus, an air inlet opening can, for example, be connected to a hot air line, or a cold air line, these two lines able to be recirculation lines connected to the enclosed space to be air-conditioned such as an aeroplane cabin or even lines connected to the outside of this enclosed space. The circulation of the airflows through the mix valve 20 is ensured by at least one airflow generating device 101 of the air-conditioning system, for example an airflow generating device 101 which can be placed in a line connected to the outlet opening 24, immediately downstream thereof as shown in FIGS. 1 to 6. The airflow generating device 101 can be a fan or any other air flow rate source able to be controlled such as an external air source driven by an electric valve or a source of compressed air from a turbine engine or the like.

Furthermore, the mix valve 20 comprises an aero-controlled regulation device 25 comprising two shutters 26, 33 respectively associated with the two inlet openings 22, 23 of the mix valve 20. A first shutter 26 associated with the inlet opening 22 of the valve 20 is a profiled shutter. The second shutter 33, named linked shutter 33, is connected to the profiled shutter 26 by at least one connecting rod 35 forming a linking mechanism 102 between these two shutters. The linked shutter 33 is associated with the second inlet opening 23 of the mix valve 20.

In order to associate the shutters 26, 33 with the openings 22, 23, each shutter is connected to the wall 21 of the mix valve 20 in proximity to the opening 22 or 23 with which it is associated. More particularly, each shutter is connected to the wall 21 of the mix valve 20 by a pivot link along an axis, named pivot axis. Thus, the profiled shutter 26 is connected to the wall 21 of the mix valve 20 by a pivot link along a pivot axis 29 and the linked shutter 33 is connected to the wall 21 of the mix valve 20 by a pivot link along a pivot axis 36. The pivot axes 29, 36 of the two shutters 26, 33 are at least substantially in parallel with each other. Preferably, the pivot axis 29 of the profiled shutter 26 is oriented so as to be at least substantially orthogonal to the direction of the airflow which it receives through the inlet opening 22. Similarly, the pivot axis 36 of the linked shutter 33 is oriented so as to be at least substantially orthogonal to the direction of the airflow which it receives through the inlet opening 23.

Furthermore, each shutter has a peripheral border, the shape of which matches that of the wall 21 of the valve 20 delimiting the opening 22 or 23 with which the shutter is associated so as to be able to plug, in the closing position, the opening 22 or 23 with which the valve is associated. Thus, such a shutter is adapted to prevent an airflow from passing through the opening 22 or 23 with which the shutter is associated. Each shutter is able to pivot between an opening end position allowing an airflow to pass through the opening with which it is associated and a closing end position preventing an airflow from passing through the opening with which it is associated. Thus, such shutters can allow an airflow to enter the mix valve 20 or to leave the mix valve 20.

In particular, the linking mechanism 102 between the shutters 26, 33 is formed of a main connecting rod 35 and two secondary connecting rods 28, 38, named small connecting rods, having dimensions smaller than those of the main connecting rod. More particularly, a first end of the small connecting rod 28 is mounted for conjoint rotation with the linked shutter 33 of the regulation device and a first end of the small connecting rod 38 is mounted for conjoint rotation with the profiled shutter 26 of the regulation device. Furthermore, a first end 40 of the main connecting rod 35 is mounted on a second end of the small connecting rod 28 by a pivot link along an axis, named connecting rod axis 37, in parallel with the pivot axis 36. A second end 49 of the main connecting rod 35 is mounted on a second end of the small connecting rod 38 by a pivot link along an axis, named connecting rod axis 30, in parallel with the pivot axis 29. Furthermore, the connecting rod axis 30 is placed at a non-zero distance from the pivot axis 29 of the profiled shutter 26. Moreover, the connecting rod axis 37 is placed at a non-zero distance from the pivot axis 36 of the linked shutter 33.

The connecting rod 35 as well as the small connecting tods 28 and 38 are rigid rods.

In the illustrated embodiment and preferably, the linking mechanism 102 (connecting rod 35 and small connecting rods 28, 38) extends to the outside of the mix chamber 98.

Nevertheless, there is nothing to prevent, in an alternative arrangement which is not shown, the linking mechanism 102 (connecting rod 35 and small connecting rods 28, 38) between the shutters from being placed within the mix chamber 98 of the mix valve 20. More particularly, when the linking mechanism 102 is placed within the mix chamber 98, the connecting rod 35 has, in at least one direction transverse to the circulation direction of the airflows in the mix valve 20, a width as small as possible so as to disrupt this circulation to the least possible extent.

Furthermore, the small connecting rods 28, 38 of the linking mechanism 102 can be placed within the mix chamber 98 and the connecting rod 35 can be placed outside of the mix valve 20. There is also nothing to prevent the connecting rod 35 from being placed within the mix valve 20 and the small connecting rods 28, 38 from being placed outside of the mix valve 20 (by providing appropriate links through the openings of the wall).

Advantageously and in accordance with the invention, the profiled shutter 26 has a cambered blade profile defining a leading edge 47, a trailing edge 27, an intrados 45 which is more concave and an extrados 46 which is more convex. Furthermore, the profiled shutter 36 has a non-constant thickness between its leading edge and its trailing edge.

The airflow incident on the profiled shutter 26 separates at the leading edge 47 into an airflow 42 flowing along the intrados 45 and an airflow 43 flowing along the extrados 46 of the shutter. The aerodynamic energy of the airflow incident on the profiled shutter 26 thus allows an aerodynamic force to be exerted on this profiled shutter 26 so as to cause it to rotate towards the opening end position even though the incoming airflow incident on the profiled shutter 26 is an air flow, named low-pressure airflow, with a relative static pressure greater than or equal to 2 hPa. For example, the profiled shutter 26 is adapted to be able to be caused to move by an airflow with a relative static pressure between 5 hPa and 10 hPa.

Furthermore, an aerodynamic force on the profiled shutter 26 can likewise result from a Venturi effect which can be formed by a converging airflow 42 passage 44 in the form of a constriction, i.e. a passage 44 having a cross-section decreasing over its length downstream (in the direction of circulation of the airflow), in particular between the profiled shutter 26 and the wall 21 of the mix valve, in which the airflow accelerates. In particular, this passage 44 is formed when the profiled shutter 26 is in the opening end position between the intrados 45 of the profiled shutter 26 and a portion facing the wall 21. This Venturi effect generates a lift directed from the intrados 45 towards the wall 21 of the mix valve 20. This Venturi effect allows the profiled shutter 26 to be held, at least in part, in this opening end position. The Venturi effect is also able to accelerate the outgoing airflow towards the outlet opening 24 and to facilitate the evacuation of this airflow out of the mix chamber 98.

Furthermore, the profiled shutter 26 is caused to rotate towards its opening end position when the division of the torque applied to the pivot axis 29 of the profiled shutter 26 and caused by the aerodynamic force exerted by the airflow 42, 43 on the profiled shutter 26 by the length of the small connecting rod 38 is greater than the division of the torque applied to the pivot axis 36 of the linked shutter 33 and caused by an aerodynamic force exerted by the airflow 41 on the linked shutter 33 by the length of the small connecting rod 28. The movement of the profiled shutter 26 can thus be obtained by adjusting the difference in length of the small connecting rods 28, 38. Thus, based on the torque applied to the pivot axis 29 of the profiled shutter 26 and on the torque applied to the pivot axis 36 of the linked shutter 33, the lengths of the small connecting rods 28, 38 can be selected so as to be equal or different such that the length of the small connecting rod 28 can be greater than or less than the length of the small connecting rod 38.

In particular, in the embodiments of the invention in which the small connecting rods 28, 38 have the same length, the profiled shutter 26 is caused to rotate towards its opening end position when a force exerted on the small connecting rod 38 under the effect of the aerodynamic force exerted by the flows 42, 43 on the profiled shutter 26 is greater than a force exerted on the small connecting rod 28 under the effect of the aerodynamic force exerted by the airflow 41 on the linked shutter 33.

In certain embodiments, the distance between the pivot axis 29 of the profiled shutter 26 and the connecting rod axis 30 of this same shutter is different from that of the linked shutter 33. Thus, the profiled shutter 26 and the linked shutter 33 are caused to move by the linking mechanism 102 at different angles with respect to their opening and closing end positions.

Furthermore, the pivot axis 29 of the profiled shutter 26 passes at least substantially through the aerodynamic centre of this profiled shutter 26 (i.e. the fixed point with respect to which the moment of the aerodynamic force is constant and non-zero regardless of the incidence of the incident airflow). Such an arrangement of the pivot axis 29 allows the rotation of the profiled shutter 26 about the pivot axis to be optimised. Furthermore, the pivot axis 29 is offset with respect to the centre of pressure of the profiled shutter 26 (i.e. the point of application of the resultant of the pressure/suction forces generated by the intrados and extrados of the fin) when this is in the closing end position so as to cause this profiled shutter 26 to rotate towards the opening end position.

When the profiled shutter 26 is in the closing end position, the extrados 46 of the profiled shutter 26 is oriented towards the opening 22 with which the shutter is associated, and the intrados 45 is oriented towards the mix chamber 98 of the mix valve 20. Nevertheless, there is nothing to prevent, in the closing end position, the extrados 46 of the profiled shutter 26 from being oriented towards the mix chamber 98 of the mix valve 20, and the intrados 45 from being oriented towards the opening 22 with which the profiled shutter 26 is associated.

Furthermore, at least one end position of each shutter can be defined by a stop formed by the wall 21 and against which the shutter abuts in this end position. A stop can be placed on the valve such that part of a shutter 26, 33 can be contacted against this stop so as to block the movement of this shutter 26, 33. Thus, in certain embodiments a stop is placed such that one end of a shutter 26, 33 having the trailing edge of this shutter, or even the leading edge of this shutter, can be brought into contact with this stop. Nevertheless, there is nothing to prevent a stop being provided which is placed such that a portion in the middle of one side of a shutter 26, 33 can be brought into contact with this stop. Furthermore, in certain advantageous embodiments, a shutter 26, 33 returns into contact with the stop at a single point so as to minimise the tapping noise.

A rib 31 of the wall 21 protruding inside the mix valve 20 is used as a stop for the closing end position of the profiled shutter 26. Thus, when the profiled shutter 26 is in the closing end position, its trailing edge 27 is in contact with the rib 31. A stop for the closing end position of the linked shutter 33 is formed by an edge 32 of the wall 21 bent towards the interior of the mix valve 20. Thus, when the linked shutter 33 is in the closing end position, a face 34 of the linked shutter 33 facing the opening 23 is in contact with the bent edge 32 at the trailing edge 48 of the linked shutter 33.

Furthermore, the distance between the pivot axis 29 and the connecting rod axis 30, the distance between the pivot axis 36 and the connecting rod axis 37 as well as the length of the connecting rod must be designed to avoid blocking and keeping the aero-controlled regulation device 25 in a single position. To do this, the angle formed between the small connecting rod 28 and the connecting rod 35 must, for example, never reach, between the opening end position and the closing end position inclusive of each shutter 26, 33, the angular value of 0° or 180° corresponding to the limit positions not allowing the shutters 26, 33 to move when said positions are reached. Similarly, the angle formed between the small connecting rod 38 and the connecting rod 35 must, for example, never reach the angular value of 0° or 180° corresponding to the limit positions each defining a position in which the shutters 26, 33 will not be able to be caused to rotate in an opposite rotational direction. A stop can thus be placed so as to block the movement in one rotational direction of a first shutter 26, 33 of an aero-controlled regulation device 25 between its limit positions.

The profiled shutter 26 is adapted to pivot towards the opening end position when the airflow generating device 101 is active. More particularly, the incoming airflow in the opening 22 under the effect of the airflow generating device 101 is incident on the profiled shutter 26. The aerodynamic energy of this airflow 43, 42 incident on the profiled shutter 26 causes the profiled shutter 26 to rotate towards an opening end position.

The linking mechanism 102 allows the mechanical forces of the movement of the profiled shutter 26 to be tranferred to the linked shutter 33 and to cause said shutter to rotate under the effect of the rotational movement of the profiled shutter 26. Thus, the shutters 26 and 33 of the aero-controlled regulation device 25 can pivot together under the effect of the aerodynamic energy of the airflow being exerted on the profiled shutter 26.

The airflow rate generated by the airflow generating device 101 at the outlet of the mix valve 20 is adapted to take into account the load losses induced in the mix valve 20. The airflow generating device 101 can be controlled and actuated by an automated regulation arrangement of the air-conditioning system. Furthermore, the airflow generating device 101 can be selected so as to allow different airflow rates to be generated, which can vary in a continuous or discrete manner. Thus, the airflow generating device 101 can be controlled as so to adjust the airflow rate so as to be able to place the shutters 26, 33 of the aero-controlled regulation device 25 in at least one intermediate position between their opening end position and their closing end position. In particular, when the shutters 26, 33 are placed in an intermediate position, the airflows 41 and 42, 43 mix. This intermediate position can be held owing to a balance of the aerodynamic forces being respectively exerted by the airflows 42 and 43, and 41 on the shutters 26, 33 respectively.

In certain embodiments, the airflow 42, 43 can be an airflow recycled from the airflow exiting the mix valve 20 through the air outlet opening 24, for example after this latter airflow has passed into the enclosed space to be air-conditioned.

In the first embodiment shown in FIGS. 1 to 6, the profiled shutter 26 and the linked shutter 33 pivot together in the same rotational direction but oppositely with respect to their end positions and to their opening and closing directions such that when the profiled shutter 26 pivots towards a closing end position, the linked shutter 33 pivots towards an opening end position, or vice-versa.

In the first illustrated embodiment, the linked shutter 33 does not have a camber but has a symmetrical profile. Nevertheless, there is nothing to prevent a linked shutter 33 with a blade profile being provided.

In the closing end position, the linked shutter 33 extends transversely to the opening 23 and receives, from the latter, an airflow under a pressure sufficient to cause the linked shutter 33 to pivot and to drive it towards its opening end position, the linked shutter 33 thus causing the profiled shutter 26 to rotate towards its closing end position via the linking connecting rod 35 when the airflow generating device 101 is interrupted.

Thus, the aero-controlled regulation device of this first embodiment operates in the following manner.

When the airflow generating device 101 is stopped, i.e. set to the inactive state, an airflow 41 fed to the inlet 23 of the valve drives the linked shutter 33 towards its opening end position and the profiled shutter 26 towards its closing end position. In this phase, the linked shutter 33 is a driving shutter and the profiled shutter 26 is a driven shutter. The profiled shutter 26 is a non-return shutter which prevents the airflow entering through the inlet opening 23 of the linked shutter 33 from passing towards the other inlet opening 22 with which the profiled shutter 26 is associated. This airflow entering through the inlet opening 23 is thus fed directly towards the outlet opening 24.

When the airflow generating device 101 is started, i.e. set to the active state, an incoming airflow generated in the inlet opening 22 and incident on the profiled shutter 26 exerts, on this profiled shutter 26, a pivoting moment of a value sufficient to cause the rotation of the profiled shutter 26 and the linked shutter 33 against the incoming airflow 41 still received at the inlet opening 23 on the linked shutter 33, and the aerodynamic forces described above exerted by this low-pressure incident airflow on the profiled shutter 26 are sufficient to allow this pivoting movement of the two shutters 26, 33, whereby the profiled shutter 26 moves towards its opening end position and the linked shutter 33 moves towards its closing end position.

The shutters 26, 33 and the connecting rod 35 of the aero-controlled regulation device of the valve in accordance with the invention can be formed of any suitable material which is as lightweight and rigid as possible, thereby allowing a greater sensitivity to the aerodynamic force exerted by the airflows on the shutters and thus the shutters of an aero-controlled regulation device to be caused to pivot with a minimised airflow.

Furthermore, in certain embodiments, a profiled shutter 26 can comprise a recess 103 allowing this shutter to be reduced in weight and its centre of gravity to be moved towards its leading edge 47.

In a second embodiment shown in FIG. 7, the mix valve 20 has two air inlet openings 55, 56 and one air outlet opening 57.

A regulation device is associated with the two air inlet openings 55, 56. In particular, the regulation device comprises a linked shutter 52 associated with the air inlet opening 56 and a profiled shutter 51 associated with the air inlet opening 55. A connecting rod 54 connects the shutters 51, 52 of the regulation device such that the shutters 51, 52 pivot oppositely to each other.

The airflow generating device 101 is able to generate an airflow 50 arriving at the air inlet opening 55 of the valve 20.

The airflow generating device 101 is initially set to be stopped, i.e. inactive. The profiled shutter 51 is initially in a closing position in which its intrados side is oriented towards the opening 55 and its end having the trailing edge of the profiled shutter 51 is placed against a stop 53 of the valve 20 on the intrados side. The linked shutter 52 is initially in an opening end position, thereby allowing an incoming airflow 100 to be introduced into the mix chamber 98 of the valve 20.

The profiled shutter 51 initially prevents this latter airflow 100 from passing through the opening 55, the airflow 100 from the air inlet opening 56 is fed solely to the air outlet opening 57.

When the airflow generating device 101 is set to the active state, the airflow 50 generated by the airflow generating device 101 having a flow rate greater than the flow rate of the incoming airflow 100 passing through the opening 56 associated with the linked shutter 52 exerts an aerodynamic force on the profiled shutter 51 such that this profiled shutter 51 pivots towards an opening end position to allow the airflow 50 generated by the airflow generating device 101 to pass into the mix chamber 98 of the valve 20 via the opening 55 associated with this profiled shutter 51. The rotation towards an opening end position of the profiled shutter 51 allows the linked shutter 52 to be closed such that it prevents the airflow 100 from being introduced into the mix chamber 98 through the opening 56 associated with the linked shutter 52. The airflow 50 generated by the airflow generating device 101 is thus fed in the valve solely to the air outlet opening 57.

In a third embodiment shown in FIG. 8, the mix valve 20 likewise has two air inlet openings 63, 64 and one air outlet opening 65 and a regulation device is associated with the two air inlet openings 63, 64.

The regulation device differs from the second embodiment in that it comprises two linked shutters 59. More particularly, the two linked shutters 59 are associated with a single air inlet opening 64. These two linked shutters 59 are connected to each other by a connecting rod 61 such that they pivot in the same opening or closing direction, the linked shutters 59 thus always being in parallel with each other. These linked shutters 59 are adapted to block the opening 64 with which they are associated when they are in the closing end position. Furthermore, one of the linked shutters 59 is connected to the profiled shutter 58 by a second connecting rod 62 such that they pivot oppositely to each other.

The airflow generating device 101 is able to generate an airflow 50 arriving at the air inlet opening 63 of the valve 20.

The airflow generating device 101 is initially stopped, i.e. inactive. The profiled shutter 58 is initially in a closing position in which its intrados side is oriented towards the opening 63 and its end having the trailing edge of the profiled shutter 58 is placed against a stop 60 of the valve 20 on the intrados side.

The linked shutters 59 are initially in an opening end position, thereby allowing an incoming airflow 100 to be introduced into the mix chamber 98 of the valve 20. Since the profiled shutter 58 initially prevents this latter airflow 100 from passing through the opening 63, the airflow 100 from the air inlet opening 64 is fed solely to the air outlet opening 65.

When the airflow generating device 101 is active, the airflow 50 generated by the airflow generating device 101 having a flow rate greater than the flow rate of the airflow 100 exerts an aerodynamic force on the profiled shutter 58 such that it pivots towards an opening end position to allow the airflow 50 generated by the airflow generating device 101 to pass into the mix chamber 98 of the valve 20. The rotation towards an opening end position of the profiled shutter 58 allows the linked shutters 59 to be closed such that it prevents the airflow 100 from being introduced into the mix chamber 98. The airflow 50 generated by the airflow generating device 101 is thus sent to the air outlet opening 65.

In a fourth embodiment shown in FIG. 9, the mix valve 20 comprises one air inlet opening 70, one air inlet/outlet opening 71 and one air outlet opening 72.

A regulation device comprises a linked shutter 67 associated with the air inlet opening 70 and a profiled shutter 66 associated with the air outlet opening 72. A connecting rod 69 connects the shutters 66, 67 of the regulation device such that the shutters 66, 67 pivot oppositely to each other.

The airflow generating device 101 is able to generate an airflow 50 arriving at the inlet/outlet opening 71 of the valve 20.

The airflow generating device 101 is initially stopped, i.e. inactive. The profiled shutter 66 is initially in a closing position in which its extrados side is oriented towards the air outlet opening 72 and one of its ends is placed against a stop 68 of the valve 20 on the intrados side.

The linked shutter 67 is initially in an opening end position, thereby allowing an incoming airflow 100 to be introduced into the mix chamber 98 of the valve 20. Since the profiled shutter 66 initially prevents this latter airflow 100 from passing through the air outlet opening 72, the airflow 100 from the air inlet opening 70 is fed solely to the air inlet/outlet opening 71.

When the airflow generating device 101 is active, the airflow 50 generated by the airflow generating device 101 having a flow rate greater than the flow rate of the airflow 100 exerts an aerodynamic force on the profiled shutter 66 such that it pivots towards an opening end position to allow the airflow 50 generated by the airflow generating device 101 to pass into a ventilation line connected to the air outlet opening 72. More particularly, the rotation towards an opening end position of the profiled shutter 66 allows the linked shutter 67 to be closed such that it prevents the airflow 100 from being introduced into the mix chamber 98. The airflow 50 generated by the airflow generating device 101 is thus solely sent to the ventilation line connected to the air outlet opening 72.

In a fifth embodiment shown in FIG. 10, the mix valve 20 has one air inlet opening 77 and two air outlet openings 78, 79.

A regulation device is associated with all of the openings 77, 78, 79 of the valve 20. In particular, the regulation device comprises two linked shutters 74, 75 fitted together for conjoint rotation, a first linked shutter 74 being associated with the air outlet opening 78 and a second linked shutter 75 being associated with the air outlet opening 79. The device likewise comprises a profiled shutter 73 having dimensions smaller than those of the opening 77 with which it is associated. A connecting rod 99 mounts the profiled shutter 73 to the linked shutters 74, 75 of the regulation device such that when the profiled shutter 73 is in the opening end position the first linked shutter 74 is closed and the second linked shutter 75 is open and when the profiled shutter 73 is in the closing end position the first linked shutter 74 is open and the second linked shutter 75 is closed. In this embodiment, the profiled shutter 73 is used merely to guide an airflow, its shape being adapted to direct an airflow towards the open linked shutter.

The airflow generating device 101 is able to generate an airflow 50 exiting the valve 20 through the air outlet opening 78 of the valve 20.

The airflow generating device 101 is initially stopped, i.e. inactive. The profiled shutter 73 is initially in an opening end position, allowing the airflow 100 to pass towards the mix chamber 98 of the valve 20. The first linked shutter 74 is initially kept closed by the aerodynamic force generated by the airflow 100 on the profiled shutter 73. The first linked shutter 74, being closed, is thus positioned against a stop 76 preventing the airflow 100 from exiting the valve 20 through the air outlet opening 78. The second linked shutter 75 is initially open allowing the airflow 100 to exit the valve 20 through the air outlet opening 79.

When the airflow generating device 101 is active, the airflow 50 generated by the airflow generating device 101 having a flow rate greater than the flow rate of the airflow 100 exerts an aerodynamic force on the first linked shutter 74 such that it pivots towards an opening end position. The rotation towards an opening end position of the first linked shutter 74 allows the second linked shutter 75 to be closed, preventing the airflow 50 generated by the airflow generating device 101 from exiting through the air outlet opening 79.

In a sixth embodiment shown in FIG. 11, the mix valve 20 has one air inlet opening 84, through which an airflow 100 passes, and two air outlet openings 85, 86.

A regulation device is associated with the two air outlet openings 85, 86. In particular, the regulation device comprises a linked shutter 81 associated with the air outlet opening 86 and a profiled shutter 80 associated with the air outlet opening 85. A connecting rod 83 is mounted on the shutters 80, 81 of the regulation device such that the shutters 80, 81 pivot oppositely to each other.

The airflow generating device 101 is able to generate an airflow 50 arriving at the air inlet opening 84 of the valve 20.

The airflow generating device 101 is initially stopped, i.e. inactive. The profiled shutter 80 is initially in a closing end position in which its intrados side is oriented towards the air outlet opening 85 and its end having the trailing edge of the profiled shutter 80 is placed against a stop 82 of the valve 20 on the extrados side. The linked shutter 81 is initially in an opening end position allowing the airflow 100 to exit the valve 20 through the air outlet opening 86.

When the airflow generating device 101 is active, the airflow 50 generated by the airflow generating device 101 having a flow rate greater than the flow rate of the airflow 100 exerts an aerodynamic force on the profiled shutter 80 such that it pivots towards an opening end position. The rotation towards an opening end position of the profiled shutter 80 allows the linked shutter 81 to be closed such that the airflow 50 generated by the airflow generating device 101 is sent to the air outlet opening 85.

In a seventh embodiment shown in FIG. 12, the mix valve 20 has three air inlet openings 94, 95, 96 and one air outlet opening 97.

A regulation device is associated with the three air inlet openings 94, 95, 96. In particular, the regulation device comprises a linked shutter 89 associated with the air inlet opening 94, a first profiled shutter 87 associated with the air inlet opening 95 and a second profiled shutter 88 associated with the air inlet opening 96. The regulation device likewise comprises two connecting rods 92, 93, each connecting rod mounting each profiled shutter 87, 88 on the linked shutter 89 such that the profiled shutters 87, 88 pivot oppositely with respect to the linked shutter 89.

The airflow generating device 101 is able to generate an airflow 50 arriving at the air inlet openings 95, 96 of the valve 20.

The airflow generating device 101 is initially stopped, i.e. inactive. The profiled shutters 87, 88 are initially in a closing position in which their intrados side is oriented towards the opening with which they are associated and their end having the trailing edge is placed against a stop 90, 91 of the valve 20 on their intrados side. The linked shutter 89 is initially in an opening end position, thereby allowing an incoming airflow 100 to be introduced into the mix chamber 98 of the valve 20 via the air inlet opening 94. Since the profiled shutters 87, 88 initially prevent this latter airflow 100 from passing through the air inlet openings 95, 96, the airflow 100 from the air inlet opening 94 is fed solely to the air outlet opening 97. When the airflow generating device 101 is active, the airflow 50 generated by the airflow generating device 101 having a flow rate greater than the flow rate of the airflow 100 exerts an aerodynamic force on the profiled shutters 87, 88 such that they pivot towards an opening end position to allow the airflow 50 generated by the airflow generating device 101 to pass therethrough. The rotation towards an opening end position of the profiled shutters 87, 88 allows the linked shutter 89 to be closed such that it prevents the airflow 100 from being introduced into the mix chamber 98. Thus, the airflow 50 generated by the airflow generating device 101 being introduced into the mix valve 20 through the air inlet openings 95, 96 is solely sent to the air outlet opening 97.

The invention thus relates to a valve comprising an aero-controlled regulation device able to regulate the airflows passing through at least three openings of the valve such that the airflow extracted from the valve through at least one air outlet opening depends upon the arrangement of the aero-controlled regulation device in the mix valve.

The invention can be varied in many ways with respect to the embodiments described above and illustrated in the figures. In particular, a linked shutter of a regulation device of the valve can be in the shape of a blade. Furthermore, an aerodynamic shutter in the shape of a blade profile of a regulation device can be oriented such that the intrados or the extrados faces the opening associated with this shutter. Furthermore, a connecting rod can link more than two shutters of a regulation device to each other.

A valve in accordance with the invention can be incorporated in an air-conditioning system of a vehicle such as an aircraft, a land vehicle, a ship . . .

1) Air mix valve comprising:
a wall (21) delimiting an internal volume of the valve and having at least three openings,
at least one airflow-regulating device (25) comprising:
at least two shutters (26, 33) placed in the internal volume of the valve, at least one of which, named aerodynamic shutter, is arranged with respect to one of the openings so as to be able to receive an airflow passing through this opening,
a linking mechanism (102) between at least two shutters (26, 33),
at least one of the shutters being guided with respect to the wall (21), each of the shutters (26, 33) being arranged and guided so as to be able to be caused to move with respect to the wall (21),
wherein:
at least one airflow-regulating device (25), named aero-controlled regulation device (25), is mounted to be freely movable with respect to the wall (21), so as to be able to be displaced exclusively under the effect of variations in at least part of the airflow passing through at least some of the openings,
at least one aerodynamic shutter of at least one aero-controlled regulation device (25), named profiled shutter (26), has the shape of a blade profile comprising a leading edge and a trailing edge and having a non-constant thickness between its leading edge and its trailing edge, so as to be able to be caused to move by the aerodynamic energy of at least one airflow (42, 43) which is incident on this profiled shutter (26),
at least one shutter, named linked shutter (33), of the aero-controlled regulation device (25), is connected to at least one profiled shutter (26) of this aero-controlled regulation device (25) by a linking mechanism (102) arranged such that such a linked shutter (33) is caused to move by a movement of at least one profiled shutter (26) to which it is connected by the linking mechanism (102).

2) Valve according to claim 1, wherein at least one profiled shutter (26) and at least one linked shutter (33) of an aero-controlled regulation device (25) are adapted to be able to be held in a position exclusively under the effect of at least part of an airflow passing through at least some of the openings.

3) Valve according to claim 1, wherein at least one profiled shutter (26) has a cambered blade profile.

4) Valve according to claim 3, wherein at least one profiled shutter (26) is cambered so as to be able to form a converging/diverging passage (44) of airflow (42) between this shutter and the wall (21).

5) Valve according to claim 1, wherein each shutter of a regulation device (25) is articulated with respect to the wall (21) by a pivot link so as to be able to pivot between two end positions.

6) Valve according to claim 5, wherein each profiled shutter (26) of an aero-controlled regulation device (25) is articulated to the wall (21) by a pivot link along a pivot axis (29) passing at least substantially through an aerodynamic centre of this profiled shutter (26).

7) Valve according to claim 6, wherein that the pivot axis (29) of a profiled shutter (26) is offset with respect to a point of application, named centre of pressure, of the resultant of the aerodynamic forces generated on this profiled shutter (26).

8) Valve according to claim 1, wherein each shutter (26, 33) of at least one aero-controlled regulation device (25) is associated with an opening, named associated opening (22, 23), having a passage cross-section, the surface area of which depends upon the position of said shutter (26, 33).

9) Valve according to claim 8, wherein each shutter (26, 33) associated with an opening of an aero-controlled regulation device (25) is adapted to be able to pivot between an opening end position, allowing an airflow to pass through the associated opening, and a closing end position, preventing at least in part an airflow from passing through the associated opening.

10) Valve according to claim 8, wherein at least one shutter (26, 33) associated with an opening of an aero-controlled regulation device (25) is arranged to be able to be caused to pivot towards a closing end position when at least one other shutter (26, 33) of the same aero-controlled regulation device (25) pivots towards an opening end position.

11) Valve according to claim 1, wherein the linking mechanism (102) between the shutters of a regulation device (25) comprises at least one connecting rod (35, 28, 38) connecting two shutters (26, 33) of this regulation device (25).

12) Valve according to claim 5, wherein the pivot link articulating each shutter (26, 33) to the wall (21), and a link articulating each shutter (26, 33) to the linking mechanism (102), are pivot links along axes which are in parallel with each other and offset with respect to each other.

13) Valve according to claim 5, further comprising at least one stop (31, 32) able to limit the rotation of at least one shutter (26, 33) of a regulation device (25) in one direction about the axis (29, 36) of the pivot link articulating the shutter to the wall (21).

14) Air-conditioning system further comprising at least one air mix valve according to claim 1.

15) Air-conditioning system according to claim 14, further comprising at least one airflow generating device (101) able to generate a low-pressure airflow (42, 43) which can exert an aerodynamic force on at least one profiled shutter (26) of an aero-controlled regulation device (25) of an air mix valve.

16) Vehicle—in particular an aircraft—comprising an air-conditioning system according to claim 14.

17. Valve according to claim 2, wherein at least one profiled shutter (26) has a cambered blade profile.

18. Valve according to claim 2, wherein each shutter of a regulation device (25) is articulated with respect to the wall (21) by a pivot link so as to be able to pivot between two end positions.

19. Valve according to claim 3, wherein each shutter of a regulation device (25) is articulated with respect to the wall (21) by a pivot link so as to be able to pivot between two end positions.

20. Valve according to claim 4, wherein each shutter of a regulation device (25) is articulated with respect to the wall (21) by a pivot link so as to be able to pivot between two end positions.
